(19) United States
(12) Patent Application Publication
(10) Pub. No.: US 2018/0011846 A1
(43) Pub. Date: Jan. 11, 2018

(54) SYSTEM AND METHOD FOR MATCHING TRANSACTION ELECTRONIC DOCUMENTS TO EVIDENCING ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/658,832

(22) Filed: Jul. 25, 2017

Related U.S. Application Data
(63) Continuation-in-part of application No. 15/361,934, filed on Nov. 28, 2016.
(60) Provisional application No. 62/369,113, filed on Jul. 31, 2016.
(60) Provisional application No. 62/260,553, filed on Nov. 29, 2015.
(60) Provisional application No. 62/261,355, filed on Dec. 1, 2015.

(51) Int. Cl. G06F 17/30; G06Q 40/00; G06K 9/00

(52) U.S. Cl. CPC G06F 17/30011; G06K 9/00483; G06Q 40/12; G06K 9/00463; G06K 2209/01

(57) ABSTRACT

A system and method for matching a second electronic document to a first electronic document, the first electronic document including at least partially unstructured data of a transaction. The method includes: analyzing the at least partially unstructured data to determine at least one transaction parameter; creating a template for the first electronic document, wherein the template is a structured dataset including the determined at least one transaction parameter; determining, based on the template, a portion of the first electronic document requiring evidence; searching, based on the template, for a second electronic document, wherein the second electronic document indicates of the evidence-requiring portion; and associating the second electronic document with the first electronic document.

### CROSS-REFERENCE TO RELATED APPLICATIONS

This application claims the benefit of U.S. Provisional Application No. 62/369,113 filed on Jul. 31, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to analyzing at least partially unstructured electronic documents, and more particularly to matching electronic documents evidencing transactions to electronic documents indicating transactions.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

Typically, to reclaim VATs paid during a transaction, evidence in the form of documentation indicating information related to the transaction (such as an invoice or receipt) must be submitted to an appropriate refund authority (e.g., a tax agency of the country refunding the VAT). If the information in the submitted documentation does not match the information submitted in the reclaim request, the request is denied and no reclaim is granted. To this end, employees of organizations often manually select and submit the required documentation for VAT reclaims in the form of electronic documents (e.g., an image file showing a scan of an invoice or receipt). This manual selection introduces potential for human error due to, for example, an employee providing incorrect information in the request and/or submitting unintended documentation (e.g., an invoice for another transaction). Existing solutions for automatically verifying transactions face challenges in utilizing electronic documents containing at least partially unstructured data.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for matching a second electronic document to a first electronic document, the first electronic document including at least partially unstructured data of a transaction. The method comprises: analyzing the at least partially unstructured data to determine at least one transaction parameter; creating a template for the first electronic document, wherein the template is a structured dataset including the determined at least one transaction parameter; determining, based on the template, a portion of the first electronic document requiring evidence; searching, based on the template, for a second electronic document, wherein the second electronic document indicates of the evidence-requiring portion; and associating the second electronic document with the first electronic document.

Certain embodiments disclosed herein also include a non-transitory computer readable medium having stored thereon instructions for causing a processing circuitry to perform a process, for matching a second electronic document to a first electronic document, the first electronic document including at least partially unstructured data of a transaction, the process comprising: analyzing the at least partially unstructured data to determine at least one transaction parameter; creating a template for the first electronic document, wherein the template is a structured dataset including the determined at least one transaction parameter; determining, based on the template, a portion of the first electronic document requiring evidence; searching, based on the template, for a second electronic document, wherein the second electronic document indicates of the evidence-requiring portion; and associating the second electronic document with the first electronic document

Certain embodiments disclosed herein also include a system for matching a second electronic document to a first electronic document, the first electronic document including at least partially unstructured data of a transaction. The system comprises: a processing circuitry; and a memory, the memory containing instructions that, when executed by the processing circuitry, configure the system to: The method includes: analyzing the at least partially unstructured data to determine at least one transaction parameter; creating a template for the first electronic document, wherein the template is a structured dataset including the determined at least one transaction parameter; determining, based on the template, a portion of the first electronic document requiring evidence; searching, based on the template, for a second electronic document, wherein the second electronic document indicates of the evidence-requiring portion; and associating the second electronic document with the first electronic document.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of an electronic document analyzer according to an embodiment.

FIG. 3 is a flowchart illustrating a method for matching an evidencing electronic document to a transaction electronic document according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for matching a second evidencing electronic document to a first transaction electronic document. The transaction electronic document includes information related to a transaction (e.g., date, price, buyer, seller, etc.) and the evidencing electronic document provides evidence of the transaction. In an example implementation, the transaction electronic document may be an expense report, and the evidencing electronic document may be an expense evidence such as, e.g., a receipt or invoice. In an embodiment, a dataset is created based on the transaction electronic document. The dataset may be created by performing optical character recognition (OCR) on the transaction electronic document and identifying key fields and values of the OCR results. A template of transaction attributes is created based on the transaction electronic document dataset.

Based on the template created for the transaction electronic document, one or more portions of the transaction electronic document requiring evidence are determined. A database is searched for an evidencing electronic document evidencing the determined portions. A compatibility level indicating compatibility between the transaction electronic document and the evidencing electronic document may be determined and provided to a user.

The disclosed embodiments allow for automatic retrieval of documents providing evidentiary proof of transactions indicated in expense reports. More specifically, the disclosed embodiments include providing structured dataset templates for electronic documents, thereby allowing for retrieving evidencing documents based on electronic expense reports that are unstructured, semi-structured, or otherwise lacking a known structure. For example, the disclosed embodiments may be used to effectively analyze images of scanned expense reports for transactions, thereby allowing for more accurate recognition of portions of the expense reports requiring evidence and, consequently, of appropriate documentation evidencing the transactions.

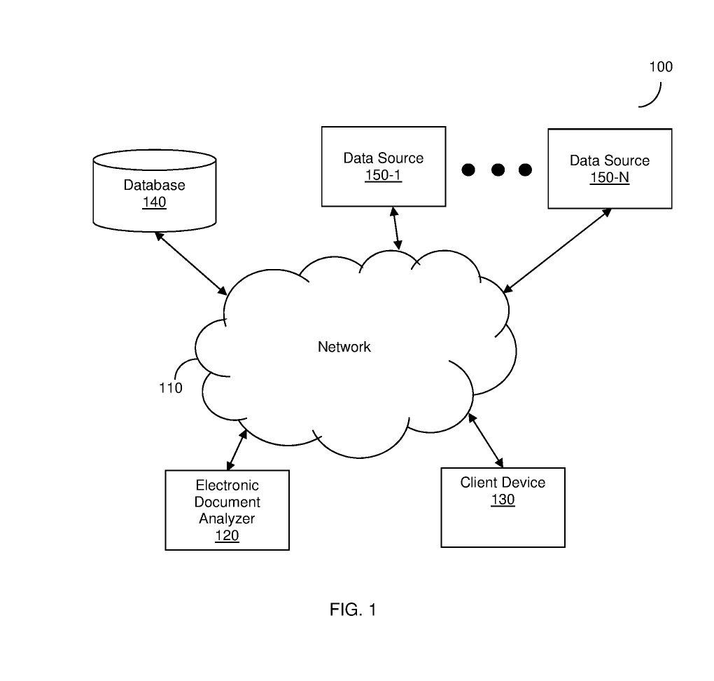

FIG. 1 shows an example network diagram 100 utilized to describe the various disclosed embodiments. In the example network diagram 100, an electronic document analyzer 120, a client device 130, a database 140, and a plurality of data sources 150-1 through 150-N (hereinafter referred to individually as a data source 150 and collectively as data sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The client device 130 is typically associated with an enterprise, and may store data related to purchases made by the enterprise or representatives of the enterprise as well as data related to the enterprise itself. The client device 130 may further store data related to expense reports and other electronic documents indicating transaction information (for example, VAT reclaim requests). The enterprise may be, but is not limited to, a business whose employees may purchase goods and services and, in particular, goods and services that may be subject to VAT taxes while abroad. The client device 130 may be, but is not limited to, a server, a database, an enterprise resource planning system, a customer relationship management system, a personal computer (PC), a personal digital assistant (PDA), a mobile phone, a smart phone, a tablet computer, or any other system storing relevant data.

The data stored by the client device 130 may include, but is not limited to, electronic documents such as transaction electronic documents indicating information related to a transaction, evidencing electronic documents providing evidence of a transaction, or both. Each electronic document may show, e.g., an invoice, a tax receipt, an expense report, a purchase number record, a VAT reclaim request, and the like. Data included in each electronic document may be structured, semi-structured, unstructured, or a combination thereof. The structured or semi-structured data may be in a format that is not recognized by the electronic document analyzer 120 and, therefore, may be treated as unstructured data.

The database 140 may store transaction electronic documents providing records of transactions and evidencing electronic documents providing evidence of transactions. Each evidencing electronic document including evidence of a transaction may be associated with a transaction electronic document indicating the transaction. To this end, the database 140 may store, e.g., sets of electronic documents, each set including a transaction electronic document indicating the transaction and one or more associated evidencing electronic documents utilized as evidence for the transaction.

The data sources 150 may store at least electronic documents that may be utilized as evidence for granting requests. Some of the data sources 150 may further store evidence requirement rules defining transaction parameters (or sets of transaction parameters) requiring evidence. The data sources 150 may include, but are not limited to, servers or devices of merchants, tax authority servers, accounting servers, a database associated with an enterprise, and the like. As a non-limiting example, the data source 150-1 may be a merchant server storing image files showing invoices for transactions made by a merchant associated with the merchant server.

In an embodiment, the electronic document analyzer 120 is configured to create a template based on transaction parameters identified using machine vision of a first transaction electronic document indicating information related to a transaction. In a further embodiment, the electronic document analyzer 120 may be configured to retrieve the transaction electronic document from, e.g., the client device 130. Based on the created template, the electronic document analyzer 120 is configured to retrieve second evidencing electronic documents document indicating information evidencing the transaction.

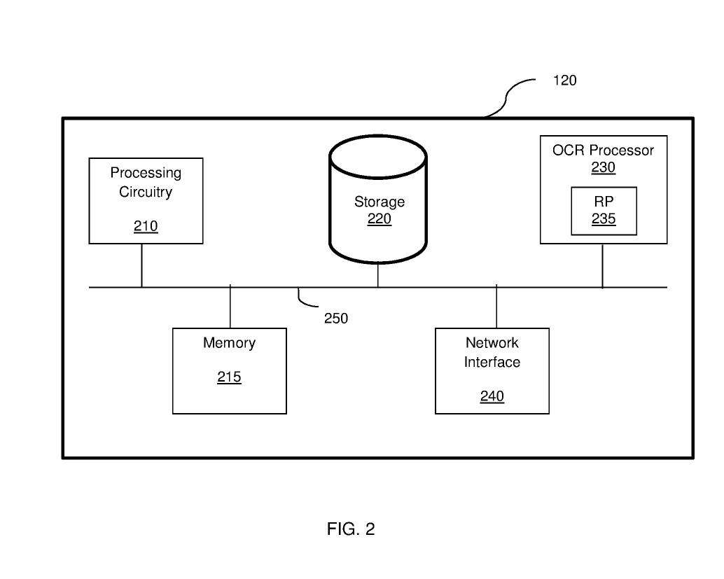

In an embodiment, the electronic document analyzer 120 is configured to create datasets based on electronic documents including data at least partially lacking a known structure (e.g., unstructured data, semi-structured data, or structured data having an unknown structure). To this end, the electronic document analyzer 120 may be further configured to utilize optical character recognition (OCR) or other image processing to determine data in the electronic document. The electronic document analyzer may therefore include or be communicatively connected to a recognition processor (e.g., the recognition processor 235, FIG. 2).

In an embodiment, the electronic document analyzer 120 is configured to analyze the created datasets to identify transaction parameters related to transactions indicated in the electronic documents. In an embodiment, the electronic document analyzer 120 is configured to create templates based on the created datasets. Each template is a structured dataset including the identified transaction parameters for a transaction.

In an embodiment, the electronic document analyzer 120 is configured to create a template based on the transaction electronic document. Based on the created template, the electronic document analyzer 120 is configured to retrieve the evidencing electronic documents for use as evidence needed to grant the request. To this end, the electronic document analyzer is configured to determine, based on evidence requirement rules and the created template, one or more portions of the transaction electronic document requiring evidence. The evidence requirement rules may define types of transaction parameters, particular transaction parameters, combinations of transaction parameters, and the like, that need to be supported by an evidencing electronic document. The evidence requirement rules may be further analyzed with respect to fields of the created templates. For example, evidence requirement rules may indicate that evidence is required for the combination of a purchase type of “hotel stay” indicated in a “type of purchase” field of the created template and a transaction parameter in a field “price.”

Using structured templates for determining whether evidencing electronic documents are required allows for more efficient and accurate determination than, for example, by utilizing unstructured data. Specifically, corresponding evidence requirement rules may be analyzed only with respect to relevant portions of a transaction electronic document (e.g., portions included in specific fields of a structured template), thereby reducing the number of instances of application of each rule as well as reducing false positives due to applying rules to data that is likely unrelated to each rule. Further, data extracted from electronic documents and organized into templates requires less memory than, for example, images of scanned documents.

In an embodiment, the electronic document analyzer 120 may be further configured to obtain the evidence requirement rules from, e.g., one or more of the data sources 150. To this end, the electronic document analyzer 120 may be configured to query the data sources 150 based on the created template. Obtaining the evidence requirement rules based on created templates allows for applying up-to-date rules, for example when tax reporting requirements change or when previously unknown rules from a new jurisdiction are to be applied.

The electronic document analyzer 120 is further configured to search in the data sources 150 based on data in the created template. As a non-limiting example, if data in the template indicates a purchase made in Israel, the evidencing electronic document may be retrieved from a data source 150-2 associated with an Israeli tax authority. As another non-limiting example, if data in the template indicates a request for VAT reclaim based on a purchase of goods from ABC Company, the second electronic document may be retrieved from a data source 150-3 associated with ABC Company.

In an embodiment, the electronic document analyzer 120 is configured to determine a compatibility level by comparing data of the transaction electronic document with data of the evidencing electronic document. The compatibility level represents a relationship between a portion of the transaction electronic document and the evidencing electronic document. The compatibility level may be, but is not limited to, a full match, a partial match, a mismatch, and the like. A full match may be determined if, for example, no difference is determined between the compared data. If a difference is determined, the compatibility level may be determined based on a predetermined threshold. For example, the threshold for prices in Euros may be 5 Euros such that a partial match is determined when a price indicated in the transaction electronic document is 90 Euros and a price in the evidencing electronic document is 91 Euros, while a mismatch is determined when a price indicated in the transaction electronic document is 90 Euros and a price in the evidencing electronic document is 80 Euros.

Determining the compatibility level may further include generating a template for the evidencing electronic document based on machine imaging analysis of the second electronic document. Data in the transaction electronic document template may be compared to corresponding data in the evidencing electronic document template. For example, values in respective “price” fields of the templates may be compared, and the difference (if any) may be compared to a partial matching location threshold.

In an embodiment, the electronic document analyzer 120 may be configured to send the compatibility level to, e.g., the client device 130, thereby prompting display of the compatibility level on the client device 130. The electronic document analyzer 120 may further send the evidencing electronic documents supporting each portion of the transaction electronic document. The user of the client device 130 may be presented with an option to accept or reject each evidencing electronic document based on the compatibility level, the evidencing electronic document, or both. If the evidencing electronic document is accepted by the user, it may be associated with the respective transaction electronic document in the database 140.

It should be noted that the embodiments described herein above with respect to FIG. 1 are described with respect to one client device 130 merely for simplicity purposes and without limitation on the disclosed embodiments. Multiple client devices may be equally utilized without departing from the scope of the disclosure.

FIG. 2 is an example schematic diagram of the electronic document analyzer 120 according to an embodiment. The electronic document analyzer 120 includes a processing circuitry 210 coupled to a memory 215, a storage 220, and a network interface 240. The electronic document analyzer 120 may also include an optical character recognition (OCR) processor 230. The components of the electronic document analyzer 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to match evidencing electronic documents to transaction electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset for matching electronic documents.

The network interface 240 allows the electronic document analyzer 120 to communicate with the client device 130, the database 140, the data sources 150, or a combination of, for the purpose of, for example, obtaining electronic documents, obtaining evidencing requirement rules, storing data, and the like.

It should be understood that the embodiments described herein are not limited to the specific architecture illustrated in FIG. 2, and other architectures may be equally used without departing from the scope of the disclosed embodiments.

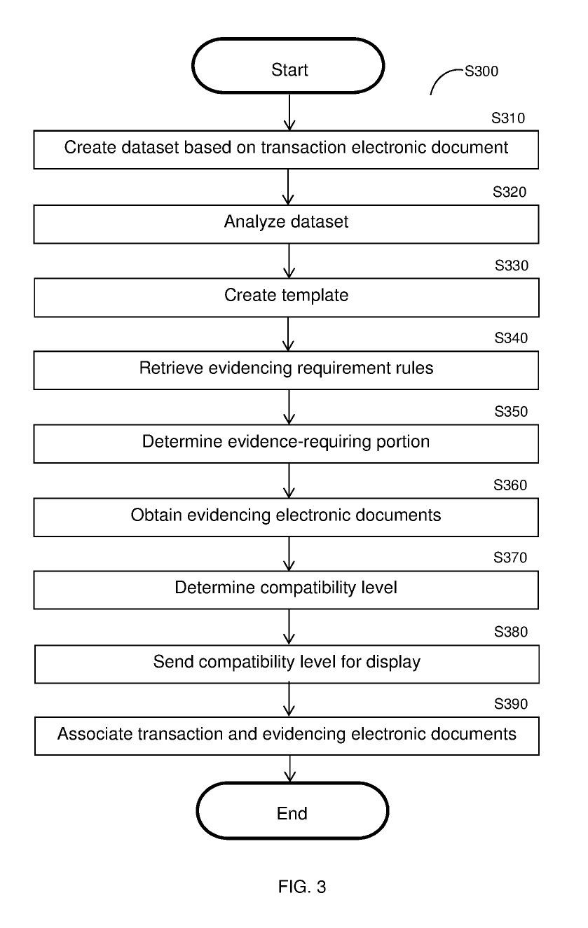

FIG. 3 is an example flowchart 300 illustrating a method for matching an evidencing electronic document to a transaction electronic document according to an embodiment. In an embodiment, the method may be performed by the electronic document analyzer 120.

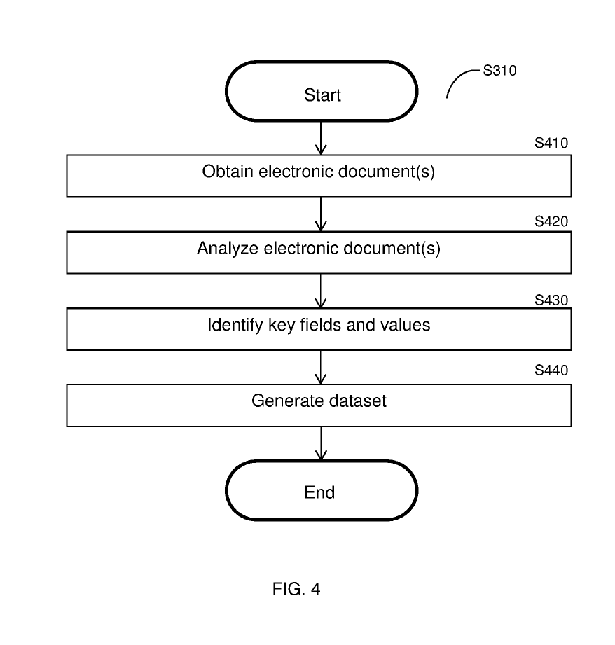

At S310, a dataset is created based on a transaction electronic document including information related to a transaction. The transaction electronic document may include, but is not limited to, unstructured data, semi-structured data, structured data with structure that is unanticipated or unannounced, or a combination thereof. In an embodiment, S310 may further include analyzing the transaction electronic document using optical character recognition (OCR) to determine data in the transaction electronic document, identifying key fields in the data, identifying values in the data, or a combination thereof. Creating datasets based on electronic documents is described further herein below with respect to FIG. 4.

At S320, the dataset created for the transaction electronic document is analyzed. In an embodiment, analyzing the dataset may include, but is not limited to, determining transaction parameters such as, but not limited to, entity identifiers (e.g., a consumer enterprise identifier, a merchant enterprise identifier, or both), information related to the transaction (e.g., a date, a time, a price, a type of good or service sold, etc.), or both. Analyzing the first dataset may also include identifying the transaction based on the dataset.

At S330, a template is created based on the dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At optional S340, evidencing requirement rules may be obtained. The evidencing requirement rules define transactions requiring evidentiary support (e.g., in the form of an invoice, receipt, or other document memorializing the transaction). The evidencing rules may further define the transactions requiring evidentiary support with respect to, e.g., types of transaction parameters (e.g., price, amount of tax paid), particular transaction parameters (e.g., rules for evidencing a purchase of goods may differ from rules for evidencing a purchase of services), combinations thereof, and the like.

The evidencing requirement rules may be retrieved based on data of the created template. To this end, S340 may include querying one or more data sources (e.g., the data sources 150, FIG. 1) based on the template. For example, for a transaction for purchase of a “hotel stay” indicated in a “transaction type” field of the template, the query may return rules for what information related to a hotel stay must be supported by documentary evidence in, e.g., an enterprise management system (e.g., for recordkeeping of a company), a tax reporting authority (e.g., for submitting a VAT reclaim request), and the like.

Obtaining the evidencing requirement rules when a template is created allows for application of current rules to the created template. For example, if tax law changes, requirements for evidencing transactions may change. Alternatively, predetermined evidencing requirement rules may be utilized.

At S350, based on the evidencing requirement rules, a portion of the transaction electronic document requiring an evidencing electronic document are determined. The determined portion may include, but is not limited to, transaction parameters included in particular fields of the template, specific transaction parameters, combinations thereof, and the like. As a non-limiting example, a specific expense description (e.g., a purchase of electronics) and a purchase price may require an evidencing electronic document.

At S360, an evidencing electronic document is retrieved based on the template. In an embodiment, S360 includes searching, based on data in the template, in at least one data source (e.g., the data sources 150, FIG. 1). The search may be further made with respect to the determined portions requiring evidence. As a non-limiting example, a transaction identification number “123456789” indicated in a “Transaction ID” field of the template that is determined as requiring an evidencing electronic document may be utilized as a search query to find the evidencing electronic document based on, e.g., metadata of the second electronic document including the transaction identification number “123456789.” In a further embodiment, S360 further includes selecting the at least one data source based on the template.

At optional S370, a compatibility level between the transaction electronic document and the evidencing electronic document may be determined. The compatibility level may be determined by comparing data of the transaction electronic document to data of the evidencing electronic document. In an embodiment, S370 includes generating a template for the evidencing electronic document (e.g., using the method described further herein below with respect to FIG. 4). To this end, S370 may further include comparing data in the transaction electronic document template with data in the evidencing electronic document template.

The compatibility level represents a degree of relation between a portion of the transaction electronic document and the corresponding evidencing electronic document and may be, for example, a full match, a partial match, a mismatch, and the like. A full match may be determined when, for example, the compared data is the same or within a predetermined fully matching threshold. A partial match or a mismatch may be determined based on, e.g., a predetermined partially matching threshold. When both thresholds are used, a partially matching threshold is lower than the fully matching threshold. The thresholds may be, for example, a threshold value, a threshold proportion, and the like.

At optional S380, the determined compatibility level may be sent for display on, for example, a client device. In an embodiment, the evidencing electronic document may also be sent.

At S390, the transaction electronic document and the evidencing electronic document are associated. To this end, S390 may further include storing the transaction electronic document, the evidencing electronic document, or both, in a database, and associating the stored electronic documents. In an embodiment, the evidencing electronic document may be further associated with particular portions of the transaction electronic document (e.g., portions indicated in specific fields of the template created for the electronic document).

As a non-limiting example, an image of a scanned expense report including a car rental in the United States is analyzed using optical character recognition to create a dataset for the image. The dataset is analyzed to identify transaction parameters including a price “$80.00” and an expense description “car rental.” A structured dataset template including the identified transaction parameters in corresponding key fields is created.

Based on the template and evidencing requirement rules, it is determined that the portion of the expense report including the price and the car rental expense description requires evidence. Using a transaction identification number of the template, an invoice for the transaction indicating a car rental with a price “$80.67” is found in a merchant server. The price of the expense report is compared to a price indicated in the invoice to determine a compatibility level of partial match. The compatibility level is sent for display on a client device. The expense report and the invoice are stored in a database and associated, thereby ensuring consistent recordkeeping.

It should be noted that the embodiments described with respect to FIG. 3 are discussed as one evidence-requiring portion of the transaction electronic document and one corresponding evidencing electronic document merely for simplicity purposes and without limitation on the disclosed embodiments. Multiple portions of the transaction electronic document may be determined as requiring evidence, and each portion may be associated with a different evidencing electronic document. The portions may be processed in series or in parallel. Further, multiple evidencing electronic documents may be found and utilized as evidence of each portion. For example, two scanned pages of an invoice may be used as evidencing electronic documents for a price of a hotel stay.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for matching a second electronic document to a first electronic document, the first electronic document including at least partially unstructured data of a transaction, comprising:
analyzing the at least partially unstructured data to determine at least one transaction parameter;
creating a template for the first electronic document, wherein the template is a structured dataset including the determined at least one transaction parameter;
determining, based on the template, a portion of the first electronic document requiring evidence;
searching, based on the template, for a second electronic document, wherein the second electronic document indicates of the evidence-requiring portion; and
associating the second electronic document with the first electronic document.

2. The method of claim 1, wherein determining the at least one transaction parameter further comprises:
identifying, in the first electronic document, at least one key field and at least one value;
creating, based on the first electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the first electronic document to determine data in the first electronic document; and
extracting, based on a predetermined list of key fields, at least a portion of the determined data, wherein the at least a portion of the determined data matches at least one key field of the predetermined list of key fields.

4. The method of claim 3, wherein analyzing the first electronic document further comprises:
performing optical character recognition on the first electronic document, wherein the determined data includes results of the optical character recognition.

5. The method of claim 1, further comprising:
comparing at least a portion of the first electronic document to the second electronic document to determine a compatibility level, wherein the compatibility level indicates a relation of the second electronic document to the evidence-requiring portion.

6. The method of claim 5, wherein the compatibility level is at least one of: a full match, a partial match, and a mismatch.

7. The method of claim 5, wherein comparing the at least a portion of the first electronic document to the second electronic document further comprises:
creating, based on the second electronic document, a template, wherein the second template is a structured dataset including data of the second electronic document; and
comparing at least a portion of the template of the first electronic document and at least a portion of the template of the second electronic document.

8. The method of claim 7, wherein comparing the first template and the second template further comprises:
comparing each portion of the first template to a corresponding portion of the second template; and
determining whether each portion of the first template matches the corresponding portion of the second template.

9. The method of claim 1, wherein the first electronic document is an expense report, wherein the second electronic document is an image showing at least one of: an invoice, and a receipt.

10. A non-transitory computer readable medium having stored thereon instructions for causing a processing circuitry to perform a process for matching a second electronic document to a first electronic document, the first electronic document including at least partially unstructured data of a transaction, the process comprising:
analyzing the at least partially unstructured data to determine at least one transaction parameter;
creating a template for the first electronic document, wherein the template is a structured dataset including the determined at least one transaction parameter;
determining, based on the template, a portion of the first electronic document requiring evidence;
searching, based on the template, for a second electronic document, wherein the second electronic document indicates of the evidence-requiring portion; and
associating the second electronic document with the first electronic document.

11. A system for matching a second electronic document to a first electronic document, the first electronic document including at least partially unstructured data of a transaction, comprising:
a processing circuitry; and
a memory, the memory containing instructions that, when executed by the processing circuitry, configure the system to:
analyze the at least partially unstructured data to determine at least one transaction parameter;
create a template for the first electronic document, wherein the template is a structured dataset including the determined at least one transaction parameter;
determine, based on the template, a portion of the first electronic document requiring evidence;
search, based on the template, for a second electronic document, wherein the second electronic document indicates of the evidence-requiring portion; and
associate the second electronic document with the first electronic document.

12. The system of claim 11, wherein the system is further configured to:
identify, in the first electronic document, at least one key field and at least one value;
create, based on the first electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the first electronic document to determine data in the first electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the first electronic document, wherein the determined data includes results of the optical character recognition.

15. The system of claim 11, wherein the system is further configured to:
compare at least a portion of the first electronic document to the second electronic document to determine a compatibility level, wherein the compatibility level indicates a relation of the second electronic document to the evidence-requiring portion.

16. The system of claim 15, wherein the compatibility level is at least one of: a full match, a partial match, and a mismatch.

17. The system of claim 15, wherein the system is further configured to:
create, based on the second electronic document, a template, wherein the second template is a structured dataset including data of the second electronic document; and
compare at least a portion of the template of the first electronic document and at least a portion of the template of the second electronic document.

18. The system of claim 17, wherein the system is further configured to:
compare each portion of the first template to a corresponding portion of the second template; and
determine whether each portion of the first template matches the corresponding portion of the second template.

19. The system of claim 11, wherein the first electronic document is an expense report, wherein the second electronic document is an image showing at least one of: an invoice, and a receipt.
